(19) United States
(12) Patent Application Publication
(10) Pub. No.: US 2006/0192310 A1
(43) Pub. Date: Aug. 31, 2006

(54) Method of manufacturing ophthalmic lenses using modulated energy

(76) Inventors: Joseph Michael Lindacher, Suwanee, GA (US); Courtney Flem Morgan, Alpharetta, GA (US)

Correspondence Address: CIBA VISION CORPORATION;PATENT DEPARTMENT, 11460 JOHNS CREEK PARKWAY, DULUTH, GA, 30097-1556, US

(21) Appl. No.: 11/359,638

(22) Filed: Feb. 22, 2006

Related U.S. Application Data
(60) Provisional application No. 60/655,970, filed on Feb. 23, 2005.

(51) Int. Cl. B29D 11/00

(52) U.S. Cl. 264/1.32; 264/1.36; 264/1.38

(57) ABSTRACT

The present invention is related to a process for efficient manufacture of bifocal, multi-focal, single vision and mass customized ophthalmic lenses by modulating an energy source according to a cure period and a cure pattern to create a maximum number of lenses with a minimum number of molds and associated tooling.

This invention claims the benefit under 35 USC §119 (e) of United States provisional application No. 60/655,970, filed Feb. 23, 2005, incorporated by reference in its entirety.

### FIELD OF THE INVENTION

The present invention is related to a process for efficient manufacture of bifocal, multifocal, and single vision ophthalmic lenses by modulating an energy source according to a cure period and a cure pattern to create a maximum number of lenses with a minimum number of molds and associated tooling.

### BACKGROUND

Contact lenses are widely used for correcting many different types of vision deficiencies. These include defects such as near-sightedness and far-sightedness (myopia and hypermetropia, respectively), astigmatism, and defects in near range vision usually associated with aging (presbyopia). Each type of defect requires a specific correction and coordinating manufacturing process or processes. Additionally, some lens-wearers may need more than one correction. For example, a person with presbyopia may also have an astigmatic vision error. Those presbyopes may require ophthalmic lenses capable of correcting both astigmatism and presbyopia. Lenses that incorporate corrections for both types of defects usually combine one or more manufacturing processes or entail a lengthier single process.

Lenses that are designed to correct the above-referenced defects may be created through molding, casting or lathe-cutting. For example, contact lenses that are manufactured in large numbers are typically produced by a mold process. In those processes, the lenses are manufactured between two molds without subsequent machining of the surfaces or edges. Such mold processes are described, for example in U.S. Pat. No. 6,113,817, which is expressly incorporated by reference as if fully set forth herein. As such, the geometry of the lens is determined by the geometry of the mold. In a typical molding system, lenses are cycled through a series of stations on a semi-continuous basis. The cyclic portion of lens production generally involves dispensing a liquid crosslinkable and/or polymerizable material into a female mold half, mating a male mold half to the female mold half, irradiating to crosslink and/or polymerize, separating the mold halves and removing the lens, packaging the lens, cleaning the mold halves and returning the mold halves to the dispensing position. The polymerization of the material is determined by the fluence of UV light applied. Similar to mold geometry, the UV radiation is generally altered for different types of lenses. As such, producing different types of lenses and powers may not be efficient because each different type of lens may require additional setup time related to mold selection, tooling selection, and/or radiation adjustment.

For lenses designed to correct defocus, there are fewer design parameters because cylinder is not needed, hence the main design parameter is the spherical power. Each different lens power requires at least one set of molding tools and/or molds. Hence, to provide a lens product line serving most optical powers, a moderate number of molding tools and/or molds are needed. For toric lenses, at least three parameters must be considered: spherical power, cylindrical power, and the orientation of the cylindrical power. The permutations of all of these powers produce a large, almost unmanageable number of unique lens stock keeping units (SKUs), and an even larger number of molding tools and molds. Similarly, for multifocal lenses, a huge number of molding tools and molds is required.

Additionally, some persons require made-to-order (MTO) or customized lenses. Each customized lens required its own molding tools and molds. As such, the cost of MTO lenses is very high and may even be cost-prohibitive.

All of these various parameters, as stated previously result in large numbers of Stock keeping units (“SKUs”). In distribution and manufacturing environments, the SKUs must be created, tracked, possibly stored and distributed. Moreover, all of the ancillary tools and molds must be created, tracked, and maintained.

### SUMMARY OF THE INVENTION

The present invention seeks to solve the problems listed herein by reducing the number of molding tools and molds to produce a large number of lenses of varying parameters. The present invention also seeks to provide a means for cost-effective production of MTO or customized lenses. In accomplishing the foregoing, there is provided, in accordance with one aspect of the present invention,

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE DRAWINGS

FIG. 1A illustrates a plan view of one embodiment of a mold carrier in an open position.

FIG. 1B shows an end sectional view of the FIG. 1A mold carrier in an open position.

FIG. 1C shows an end sectional view of the FIG. 1A mold carrier in a closed position.

### DETAILED DESCRIPTION OF THE PREFERRED EMBODIMENTS

Reference now will be made in detail to the embodiments of the invention. It will be apparent to those skilled in the art that various modifications and variations can be made in the present invention without departing from the scope or spirit of the invention. For instance, features illustrated or described as part of one embodiment can be used in conjunction with another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention. All patents and patent applications disclosed herein are expressly incorporated by reference in their entirety.

### Definitions

Unless defined otherwise, all technical and scientific terms used herein have the same meaning as commonly understood by one of ordinary skill in the art to which this invention belongs. Generally, the nomenclature used herein and the manufacturing procedures are well known and commonly employed in the art. Conventional methods are used for these procedures, such as those provided in the art and various general references. Where a term is provided in the singular, the inventors also contemplate the plural of that term.

An “ophthalmic device,” as used herein, refers to a contact lens (hard or soft), a comeal onlay, implantable ophthalmic devices used in, on or about the eye or ocular vicinity.

The term “contact lens” employed herein in a broad sense and is intended to encompass any hard or soft lens used on the eye or ocular vicinity for vision correction, diagnosis, sample collection, drug delivery, wound healing, cosmetic appearance (e.g., eye color modification), or other ophthalmic applications.

A “hydrogel material” refers to a polymeric material which can absorb at least 10 percent by weight of water when it is fully hydrated. Generally, a hydrogel material is obtained by polymerization or copolymerization of at least one hydrophilic monomer in the presence of or in the absence of additional monomers and/or macromers. Exemplary hydrogels include, but are not limited to, poly(vinyl alcohol) (PVA), modified polyvinylalcohol (e.g., as nelfilcon A), poly(hydroxyethyl methacrylate), poly(vinyl pyrrolidone), PVAs with polycarboxylic acids (e.g., carbopol), polyethylene glycol, polyacrylamide, polymethacrylamide, silicone-containing hydrogels, polyurethane, polyurea, and the like. A hydrogel can be prepared according to any methods known to a person skilled in the art.

A “crosslinkable and/or polymerizable material” refers to a material which can be polymerized and/or crosslinked by actinic radiation to obtain crosslinked and/or polymerized material which are biocompatible. Examples of actinic radiation are UV irradiation, ionized radiation (e.g. gamma ray or X-ray irradiation), radio frequency irradiation, microwave irradiation, infrared irradiation and the like.

“Polymer” means a material formed by polymerizing one or more monomers.

A “prepolymer” refers to a starting polymer which can be polymerized and/or crosslinked upon actinic radiation to obtain a crosslinked polymer having a molecular weight much higher than the starting polymer.

The term “fluid” as used herein indicates that a material is capable of flowing like a liquid.

“Fluid optical material” as used herein means a polymer, a prepolymer, a corsslinkable and/or polymerizable material, and/or a hydrogel material that is capable of flowing like a liquid.

Overview

The present invention is generally related to the manufacture and design of contact lenses. In one aspect, the present invention provides an efficient method to manufacture a maximum number of contact lenses using a minimal number of molds, tooling, and setup by modulating an energy source to create different lenses using a cure period and a cure pattern. The varied light intensity of the cure period and/or cure pattern differentially cures the fluid optical material to create a spatial distribution of refractive indices in the optical zone of a lens within the cured lens as disclosed in U.S. Pat. No. 60/592,900, filed Jul. 30, 2004, which is expressly incorporated by reference in its entirety as if fully set forth herein.

Ophthalmic lenses may be produced by double-sided molding (DSM) processes. These processes typically involve dispensing a liquid monomer into a female mold half, mating a male mold half to the female, and applying ultraviolet radiation to polymerize the monomers. Such molds may be injection molded or produced in any other feasible way known in the art. The female mold half may have a molding surface that defines the anterior (front) surface of a contact lens. The male mold half may have a molding surface that defines the posterior (back) surface of the lens.

An improvement of the DSM process is described in U.S. Pat. No. 6,113,817. This improvement may be semi-cyclic and preferably includes the steps of (a) dispensing crosslinkable and/or polymerizable material into a female mold half, (b) mating a male mold half to a female mold half to create a lens cavity; (c) applying radiation to crosslink and/or polymerize the crosslinkable and/or polymerizable material to form a lens; (d) separating the male mold half from the female mold half; (e) washing the mold halves and lens to remove unreacted crosslinkable and/or polymerizable material; (f) ensuring the lens is adjacent a selected mold half (e.g., the female mold half); (g) centering the lens within the selected mold half; (h) grasping the lens (e.g., in a central area) to remove the lens from the mold half; (i) at least partially drying the lens to remove surface water which may impair inspection of the lens; (j) inspecting the lens; (k) depositing an acceptable lens into packaging; (l) cleaning the male and female mold halves; and (m) indexing the male and female mold halves to a position for dispensing crosslinkable and/or polymerizable material. This semi-continuous, partially cyclic molding process may reuse or recycle the mold halves.

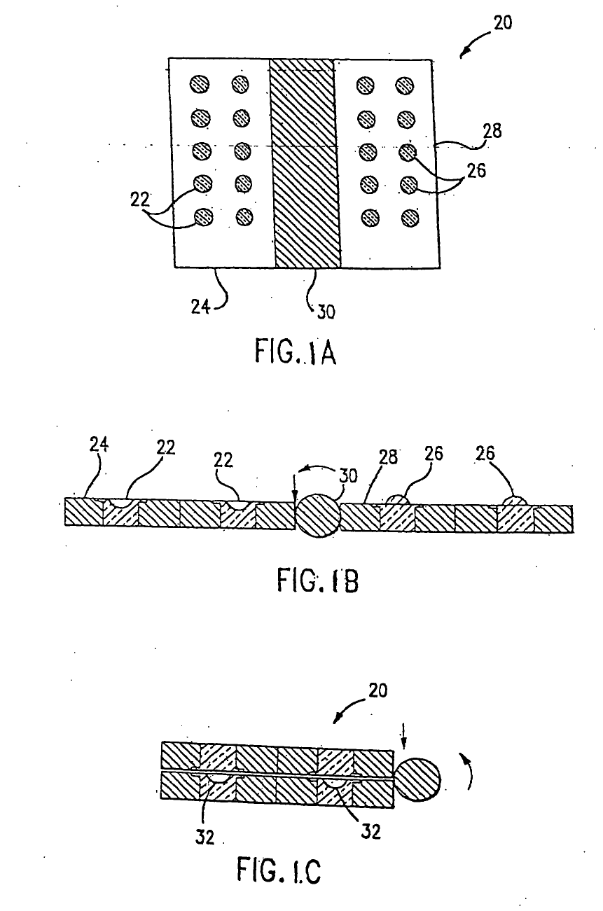

In a preferred embodiment of the present invention, the process utilizes a plurality of molds arranged and aligned in a molding carrier in order to improve process efficiency. For example, FIG. 1A illustrates a plan view of one embodiment of a molding carrier 20 having an array of ten complete molds. Molding carrier 20 includes an array of ten female mold halves 22 removably positioned in a first housing 24. Molding carrier 20 further includes an array of ten male mold halves 26 removably positioned in a second housing 28. First housing 24 is affixed to second housing 28 by a pivoting means 30, which allows second housing 28 to articulate towards first housing 24 in order to releasably mate the male and female mold halves. Thus, first housing 24 is hingedly affixed to second housing 28.

In operation, a fluid optical material (or a solution or dispersion thereof) is dispensed into female mold halves 22. Male mold halves 26 are mated with female mold halves 22 by rotating and linearly moving second housing 28, as showing by the arrow in FIG. 1B to create a mold cavity. Molding carrier 20 is shown in a closed position (i.e., molding position) in FIG. 1C. In FIG. 1C, all ten pairs of mold halves are mated, thereby defining ten molding cavities 32 in which a lens may be formed.

The mold halves may be formed from a number of materials, at least one of which transmits the desired radiation for crosslinking and/or polymerization, preferably in the ultraviolet range. One preferred material which may be used for reusable molds is quartz. Preferably only one mold half transmits sufficient radiation while the other does not. Quartz offers substantial advantages in durability, thereby allowing the molds to be reused a remarkable number of times without affecting product quality. However, quartz molds may be quite expensive. Alternatively, the mold halves may be molded from a polymeric material, at least one of which transmits the desired radiation. Examples of suitable mold materials include PMMA, polycarbonate, Zenex, Zenor, OPI Resin by Hitachi, TOPAS®, polystyrene, polypropylene and poly(acrylonitriles) such as BAREX. Because the present invention is designed to minimize the number of molds needed to produce a maximum number of lenses, quartyz or other reusable mold materials are preferred.

In a preferred embodiment, the mold halves of at least one of the set of male mold halves or the set of female mold halves includes a peripheral region which blocks light (especially UV light) during polymerizing and/or crosslinking. For the purposes of the present invention, the term “light” is used in the broadest sense, indicating an electromagnetic description of the curing irradiation. Use of such a light blocking periphery enables a precise definition of the edge of the lenses which are formed. This region may be produced by depositing a metallic or UV absorbing coating in the region outside the lens forming surfaces of the mold halves.

The design of the lens involves the creation of a zone or multiple zones within the material bulk within the lens geometry. The lens geometry may contain a single refractive index or multiple refractive indices in the optical zone of a lens, depending upon the type of correction needed. In general, most current lenses have a substantially uniform index of refraction. The present invention seeks to produce a variety of lenses with varying spatial distribution of refractive index/indices. The material's Δn, is the difference in the resultant index at the minimal required exposure and the resultant index at the maximum allowed cure exposure. As disclosed in U.S. patent application Ser. No. 60/592,900, filed 30 Jul. 2004, a material's Δn may be utilized in conjunction with highly controlled light sources, reflectors, redirectors, or modulators to influence the cure of the lens material such that various types and powers of lenses may be created using a minimal number of tools and molds.

More specifically, during the manufacturing process, the molding tool is indexed to a stage in which a form of radiation is impinged upon the molds, which allows substantially all of the radiation to transmit there through, and contact the fluid optical material to cure the lens. Preferred wavelengths of radiation are in the ultraviolet (UV) range and may be dependant upon the wavelength needed to photoactivate the fluid optical material. Preferably, the wavelength will correspond to the excitation wavelength of a photo-initiator. The appropriate intensity and exposure time needed to effect a particular index of refraction in a particular material (i.e., cure the lens) is known by those of skill in the art. In a preferred embodiment of the present invention, the type of radiation used is UV light.

In the present invention, the cure characteristics for a particular lens are known. For example, to create a lens with a power of −1.25 a particular modulation scheme is needed. The modulation scheme may include one or more cure periods and/or cure patterns. An example of a cure pattern is the Zernike polynomial basis set.

The cure period is preferably less than about 5 minutes, more preferably less than about a minute and even more preferably less than about 10 seconds. Irradiation may be accomplished in one step or stage of the process, but this is not a requirement because more than one stage of the process may be used for irradiation. For example, if a uniform stage duration of about 4 seconds is selected for the process, but an cure period of about 6 seconds is desired, two separate cure periods may be inserted into the process to provide adequate irradiation. Additionally, a pre-cure step may be used, or additional cure periods may be used. For example, uniform radiation may be applied for a short period of time to produce a uniform refractive index, such as, for example, an index of refraction of about 1.4. This pre-cure may them be followed by a second, non-uniform cure period to reach a desired index of refraction, such as about 1.5 for example. The difference in the index of refraction is proportional to the irradiance distribution and thus inversely proportional to the optical density (OD). The greater the index of refraction of the material, the greater the power difference in various optical zones of the lens. As stated previously, to provide vision correction, the index of refraction over the pupil must be uniform. By changing the refractive index of the lens in specific known areas of the lens to compensate for known deficiencies found in the uncorrected eye, the index of refraction can be normalized.

The required cure period is a function of the intensity of applied radiation, the chosen prepolymer, and the particular photoinitiator used. A preferred intensity of ultraviolet radiation for poly(vinyl alcohol) prepolymers is about 1-5 milliwatts per square centimeter, more preferably about 2 to about 3.5 mW/cm², and even more preferably about 2.8 to 3.2 mW/cm². A preferred wavelength of applied radiation is about 280 to about 380 nanometers, more preferably about 305 to about 350 nm. Other wavelengths may also be used for other fluid optical materials and their photoactivation wavelengths.

The cure pattern refers to the spatial distribution of the irradiation, which preferably cures to produce a spatial distribution of refractive indices. Many different embodiments may accomplish such a distribution.

For example, a spatial variation in cure may be induced by the application of a temporally varying radiofrequency signal applied to an appropriately designed transmitting “surface coil” antenna in position over the contact lens with a “set” cure. The RF signal will induce a spatial distribution of time varying magnetic and electric field strengths within the lens which will lead to a spatial distribution in additional curing of the polymer. The design of the surface coil is governed by well known principles in the fields of radar, telecommunications, magnetic resonance imaging and RFID inventory control. In an embodiment using a varying radiofrequency signal, an initial cure period may be applied to to establish a base structure. An electric field may then be established by placing a grounding electrode within the base curve sag of the lens mold and by placing a circular electrode (or other appropriate shapes) around the edge of the lens. Applying sufficient V to the electrodes at the edge should establish an E field in the lens that imparts orienting and mobility forces to the molecules that move to optimize the gradient in RI. These molecules can then be locked in the spatially varying curing field (UV, RF, etc.).

Spatial distribution in the example of UV cured materials may be accomplished through a gray-scale mask or digital mirror device (DMD). In one embodiment of the present invention, modulating the energy source is accomplished through use of a gray scale mask. In an embodiment using a gray scale mask, the mask has a varying OD that controls the intensity of the UV light or other energy source into the mold, forming different indices of refraction or index of refraction gradients. In an embodiment using a gray scale mask, the mask may be made using stereo lithographic techniques allowing a high degree of precision within the mask design. The design of the mask and the ability of certain parts of the mask to allow more or less penetration of the light energy may be a function of the design and fabrication process. The design of the mask preferably corresponds to the desired design of the lens in question, where the desired index of refraction imparted in the material is dependant on the amount of light energy the mask allows to penetrate into the lens mold cavity. The mask may also be affected by the light intensity.

In another embodiment of the present invention, a spatial light modulator may be used to vary the light intensity. Examples of appropriate modulators include a planar photomask or a digital mirror device (DMD).

Various illumination systems may be used within the scope of the present invention. In one embodiment, a custom ultraviolet (UV) illumination system may be used to image a planar photomask onto a convex or concave lens surface. In the present invention, it is preferable to have a substantially uniform light source, i.e., a uniform intensity distribution, which is in optical connection with a DMD.

For example, if the light source is a UV bulb, a Koehler or Abbe illumination system may be used. In another embodiment, a UV source with a liquid light guide may be used in conjunction with a homogenizer. In embodiments in which a laser light source is used, the light may be collimated and thus, further homogenization of the light may not be necessary. In another embodiment, the illumination pattern preferably compensates for non-uniformity in the curing UV field.

In a preferred embodiment, energy modulation may be accomplished using a digital mirror device (DMD). In still another embodiment, the DMD may utilize micro-electro mechanical systems (MEMS). In an embodiment using a DMD, the DMD software in conjunction with a MEMS device modulates the intensity/irradiance of the light according to an illumination scheme corresponding to the lens design to create a spatial distribution of the needed refractive indices. As stated previously, certain parameters are necessary for a complete lens design. These parameters are used to calculate the proper light intensity and pattern by particular software programs already disclosed here and their equivalents. In a preferred embodiment, the DMD and its software control a plurality of mirrors to on or off positions that are dependent upon the lens design. When the light source is incident on the DMD, the computer board associated with the DMD preferably controls the mirrors to reflect and modulate the desired intensity/irrandiance pattern onto the fluid ophthalmic material by switching them on or off. In another embodiment, the computer board associated with the mirrors may calculate and correct for distortion and other optical noise in the system.

before the manufacturing cycle begins, the lenses to be produced are determined. The design parameters are preferably stored in an electronic database. Prior to a manufacturing cycle, the database may be accessed and may be used to program certain parameters of the cycle, specifically, in the present invention, the cure processThe mold carriers and molds are selected and placed on the line accoring to this pre-determined manufacturing schedule. The mold carriers and molds preferably have a sku assocaited with them that also references the other needed parameters that are accessed by a PC controller. After the lens material is deposited in the mold, the carrier may be cycled to a curing station. An illumination controller may then access a database to determine what cure periods and patterns are needed to create the proper lens according to the schedule or SKU.

The cure period and cure pattern preferably change according to the lens design desired and mold used in a cycle. For example, if a plano mold is used, the cure pattern and periods solely affect the lens design and power as they act as the exclusive controllers of the index or indices of refraction. In another embodiment, a mold and associated tooling designed for one lens power can be used to create that power and can also be used and modified to create another power in the same cycle. In this embodiment, a mold designed to produce a lens with a power of −1.25 may be used to create a lens power of −2.5 by lengthing the cure period. In another embodiment of the present invention, one mold carrier can produce more than one type or power of lens per cycle by altering the cure period or pattern. For example,dependent upon the orientation of the carrier, two (2) molds in the carrier are exposed to a light source at one time. Therefore, because the mold carrier contains 10 male and female mold sets, five (5) different sets of lenses can be made from the same carrier by modulating the curing light according to a preset cure period or pattern. The mold carrier may be of any configuration and may include any number of sets of molds. The preceeding description is exemplary only and is not meant to be limiting.

The methods of the present invention also provide additional efficiencies. For example, less molds and tooling are needed if one type of mold can produce a multitude of lenses. Hence, setup time and captial expenditures may be reduced.

In accordance with this invention, specific types of modification are preferably used to precisely transfer energy modulation into material density modulation. Such precision results in electron density modulation and thus the desired refractive index modulation. These types of modification preferably involve a suitable PVA formula, such as that described in U.S. Pat. Nos. 5,508,317; 5,583,163; 5,789,464; and 5,849,810, which are incorporated by reference as if fully set forth herein. Other similar prepolymers, including those used to make holographic lenses, such as gelatin-based prepolymers, may also be used. These materials are described in U.S. Pat. No. 5,508,317, which is incorporated by reference as if fully set forth herein. The first preferred material modification may comprise a material formulation based on a PVA formulation as described in the patents listed above, A second material formulation preferably contains refractive index enhancing modifiers chemically attached to the hydrogel backbone that may be substituted benzaldehydes reacted with hydroxy groups of the PVA to cyclic acetals. The introduction of aromatic moieties into the polymer matrix increases the overall refractive index of the matrix, which leads to increased refractive index differences between areas of different polymer densities. Additional increase of refractive index differences is encouraged by aromat/polymer interactions, which enhance the packing order of the polymer chains in high-density areas as well as achieving higher efficiencies. Because the modifiers are chemically bond to the polymer matrix, the material remains biocompatible, without requiring additional extraction steps after the lens production.

In another preferred embodiment, a crosslinkable and/or polymerizable fluid material is an aqueous solution of one or more prepolymers and optionally one or more vinylic monomers, wherein the aqueous solution includes low molecular weight additives, such as NaCl, which exhibit a limited compatibility with a polymer resulted from the crosslinkable and/or polymerizable fluid material, but good compatibility with water. By virtue of the limited compatibility, the additive causes an osmotic gradient, which induces a contraction of a resulting polymer matrix. It is believed that the additive separates during the hologram recording period from areas of high irradiation intensity, in which the polymerizing and/or crosslinking process is initiated, into areas of low irradiation intensity. Such separation causes an osmotic gradient, followed by localized dehydration and contraction of the resulting polymer matrix. As a consequence, refractive index differences between high and low irradiated areas increase and high efficiency materials are obtained. High and low irradiated areas are caused by the pattern of interference fringes. Because, for example, NaCl is a component of the lens storage solution, no extraction process is necessary during the lens preparation process. Other additives, with similar properties may also be added, such as HEMA or other hydrophilic monomers.

To facilitate the photocrosslinking and/or polymerizing process, it is desirable to add a photoinitiator, which can initiate radical crosslinking and/or polymerizing. Exemplary photoinitators suitable for the present invention include benzoin methyl ether, 1-hydroxycyclohexylphenyl ketone, Durocure® 1173 and Irgacure® photoinitators. Preferably, between about 0.3 and about 5.0%, based on the total weight of the polymerizable formulation, of a photoinitiator is used. Additionally a sensitizer may be added to enhance the energy transer process.

In accordance with the present invention, a crosslinkable and/or polymerizable fluid material is capable of transferring energy modulation into material density modulation, which subsequently results in the desired refractive index modulation. As will be readily appreciated by those of skill in the art, many different types of lenses are possible with the present invention. Contact lenses of the invention can be either hard or soft lenses. A contact lens of the invention can be a toric, multifocal, toric multifocal contact lens, customized contact lenses, or the like. Contact lenses of the present invention may also correct more than one type of defect, such as, for example, presbyopia and astigmatism. According to the present invention, each of these types of lenses may be created by a cure period and/or cure pattern.

Soft contact lenses of the invention are preferably made from a fluid optical material, such as a silicon or fluorine-containing hydrogel or HEMA with material properties that allow modulation of a refractive index. It will be understood that any fluid optical material can be used in the production of a contact lens of the invention. Preferred materials and formulations suitable for this application preferably consist of pure or specifically modified hydrogels, preferably polyvinylalcohols (PVA) containing radiation activated crosslinkable functional groups that may be photoinitiated when exposed to a particular wavelength.

The invention has been described in detail, with particular reference to certain preferred embodiments, in order to enable the reader to practice the invention without undue experimentation. A person having ordinary skill in the art will readily recognize that many of the previous components, compositions, and/or parameters may be varied or modified to a reasonable extent without departing from the scope and spirit of the invention. Furthermore, titles, headings, example materials or the like are provided to enhance the reader's comprehension of this document, and should not be read as limiting the scope of the present invention. Accordingly, the invention is defined by the following claims, and reasonable extensions and equivalents thereof.

What is claimed is:

1. A method for manufacturing ophthalmic lenses comprising
Selecting a first lens design
Providing a fluid optical material;
Providing a first mold;
Injecting said fluid optical material into said mold;
Exposing said mold and fluid optical material to an energy source; and
modulating said energy source according to a cure period associated with said lens design.

2. The method of claim 1, further comprising modulating said energy source according to a cure pattern associated with said lens design.

3. The method of claim 1 wherein said mold is a plano mold.

4. The method of claim 1, wherein said modulation is accomplished by a gray-scale mask.

5. The method of claim 4, wherein said gray scale mask is created using stereo lithography.

6. The method of claim 1, wherein said varying modulation is accomplished by using a uniform light source in optical connection with a DMD.

7. The method of claim 1 wherein said ophthalmic lenses are selected from the group consisting of: a bifocal lens, a multifocal lens, a toric lens, a customized lens and a single vision lens.

8. The method of claim 1, wherein said ophthalmic lenses are designed to correct one or more of the following defects: myopia, hypermetropia, presbyopia, defocus, and astigmatism.

9. The method of claim 1 further comprising
selecting a second lens design
providing said fluid optical material;
providing said first mold;
injecting said fluid optical material into said first mold;
exposing said mold and fluid optical material to an energy source; and
modulating said energy source according to a cure period associated with said second lens design.

10. The method of claim 9, wherein said method produces a maximum number of ophthalmic lenses with a minimum number of molds.

11. The method of claim 1, further comprising accessing an electronic database prior to providing a first mold wherein said database contains said first lens design parameters.

12. The method of claim 9, further comprising accessing an electronic database after selecting a second lens design a first mold, wherein said database contains said second lens design parameters.

13. The method of claim 1, wherein said energy comprises, UV irradiation, ionized radiation, radio frequency irradiation, microwave irradiation, and infrared irradiation.
